(19) United States
(12) Patent Application Publication
(10) Pub. No.: US 2019/0032816 A1
(43) Pub. Date: Jan. 31, 2019

(54) Boring Head for Metal Tubing

(71) Applicant: Kwon J. PARK, Diamond Bar, CA (US)

(72) Inventor: Kwon J. PARK, Diamond Bar, CA (US)

(21) Appl. No.: 15/664,821

(22) Filed: Jul. 31, 2017

(51) Int. Cl. F16L 1/028

(52) U.S. Cl. CPC F16L 1/028; F16L 9/02

(57) ABSTRACT

A boring head for steel tubing is provided. The boring head for metal tubing comprises a cylindrical body, a conic point, and engaging female threads. The cylindrical body has inner wall and outer wall portions with predetermined inner and outer diameters respectively, and comprises a front opening, a rear opening, and a concentric rear end portion. The conic point is configured to penetrate and bore a hole through an external medium. The engaging female threads are configured to receive and engage a metal tube put into the cylindrical body, and the metal tube includes engaging male threads that are corresponding to the engaging female threads. The conic point makes a hole through the external medium, being pushed by the metal tube and leading the metal tube. In addition, the boring head may be provided with a hammering member to be engaged to the rear end of the metal tube.

### BACKGROUND OF THE INVENTION

The present invention relates to a boring head for metal tubing.

In the community, there are many occasions, in which a steel pipe is deployed through an external medium such as soil or a block of cement or concrete. In such a case, it is possible to dig up the external medium down to a desirable depth, lay the pipe, and bury them up afterwards.

However, in the above practice, the work must be time-consuming, of high cost, and messy.

Therefore, the whole procedure may be nice to be improved with a suitable tool, cutting cost and work a lot.

Hopefully with such improvements, the job can be done even without disturbing the soil or concrete block.

Especially, the boring head or boring system for a metal tube needs a further improvement to prior arts.

Accordingly, a need for a boring head for metal tubing has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a boring head for metal tubing, especially in a crowded work space. In the embodiments of the invention, the tubing may be made of metal, for an example, steel.

An aspect of the invention provides a boring head 100 for steel tubing as shown in FIGS. 1-6.

FIGS. 1-3 and 6 show the boring head 100 according to embodiments of the invention, and FIGS. 2 and 4-6 show a boring system 200 according to embodiments of the invention.

The boring head 100 can be used separately from the hammering member 120. In such a case, the rear end of the metal tube 900 may be hit by a hammer, for an example, to drive in the assembled boring head 100 and the metal tube 900 through the medium such as soil or concrete.

Alternatively, the hammering member 120 may be attached to the rear end of the metal tube 900, and the hammering member 120 at the rear end of the metal tube 900 may be hit by a hammer, for an example, to drive in the assembled boring head 100, metal tube 900, and hammering member 120 through the medium as shown in FIGS. 1 and 5.

The boring head 100 for metal tubing comprises a cylindrical body 10, a conic point 20, and a first engaging female threads 30 as shown in FIG. 3.

The cylindrical body 10 has an inner wall portion 12 and an outer wall portion with a predetermined inner diameter and a predetermined outer diameter respectively, and comprises a front opening (not shown), a rear opening 14, and a concentric rear end portion 16 as shown in FIG. 3.

The conic point 20 extends from the front opening of the cylindrical body 10, and is configured to penetrate and bore a hole through an external medium as shown in FIGS. 1 and 3.

The first engaging female threads 30 are provided on a portion of the inner wall portion 12 of the cylindrical body 10 and configured to receive and engage a metal tube 900 put into the cylindrical body 10, and the metal tube 900 is configured to include first engaging male threads 910 that are corresponding to the first engaging female threads 30 as shown FIG. 2.

The conic point 20 makes a hole through the external medium, being pushed by the metal tube 900 and leading the metal tube 900 through the hole through the external medium. That is, the conic point 20 cuts a hole through the medium while driving by some eternal force applied from behind on the rear end of the metal tube 900 or the hammering member 120.

The conic point 20 may have a predetermined cross-sectional angle, which is determined by the external medium.

The predetermined cross-sectional angle may be from about 15 degrees to about 45 degrees.

The predetermined cross-sectional angle may be from about 20 degrees to about 30 degrees.

The predetermined cross-sectional angle may be about 25 degrees. Of course, the predetermined cross-sectional angle may be determined by the hardness of the medium.

The thickness of the cylindrical body 10 may be approximately one fourth to one sixth of the diameter of the inner diameter of the cylindrical body 10. Alternatively, the thickness of the cylindrical body 10 may be determined by the material of the cylindrical body 10 and/or the hardness of the medium.

The cylindrical body 10 and the conic point 20 may be formed monolithically.

The cylindrical body 10 and the conic point 20 may be made of stainless steel.

Another aspect of the invention provides a boring system 200 for a metal tubing, which comprises a boring head 100 and a hammering member 120 as shown in FIGS. 2 and 6, for examples.

The boring head 100 is similar to the one in the previous embodiment.

The hammering member 120 is configured for receiving a rear end of the metal tube 900 and hit by an external force to drive the boring head 100 into the external medium as shown in FIG. 1.

The hammering member 120 comprises an engaging portion 122 and and a hammering portion 124 as shown in FIG. 4.

The engaging portion 122 includes second engaging female threads 126 and configured to receive the rear end of the metal tube 900, and the metal tube 900 comprises second engaging male threads 920 corresponding to the second engaging female threads 910 as shown in FIGS. 2 and 4.

The hammering portion 124 is extended from the engaging portion 122 and configured to be hit by an external force as shown in FIG. 4.

The engaging portion 122 may have a cylindrical shape and include an inner wall portion and an outer wall portion.

The second engaging female threads 126 are provided on the inner wall portion of the hammering member 120 as shown in FIG. 4.

The hammering portion 124 may have a cylindrical shape.

Alternatively, the hammering portion 124 may have a polygon pipe shape (not shown). For the exact shape of the hammering portion 124, any shape can be adopted as long as they can be hit by an external force.

The advantages of the present invention are: (1) the boring head according to the invention enables the metal tubing work much more efficiently; and (2) the boring head is simple in structure and usage.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view of a boring head installed on an end of a metal tube according to an embodiment of the invention;

FIG. 2 is a perspective view of a boring system installed with a metal tube according to an embodiment of the invention;

FIG. 3 is a perspective view of a boring head according to an embodiment of the invention;

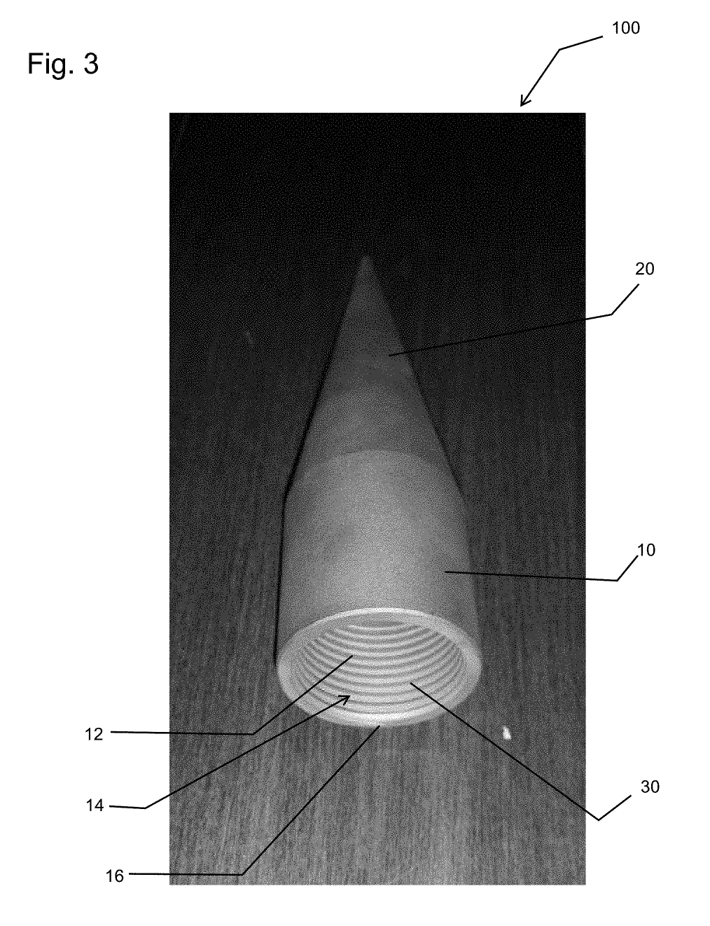

FIG. 4 is a perspective view of a hammering member according to another embodiment of the invention;

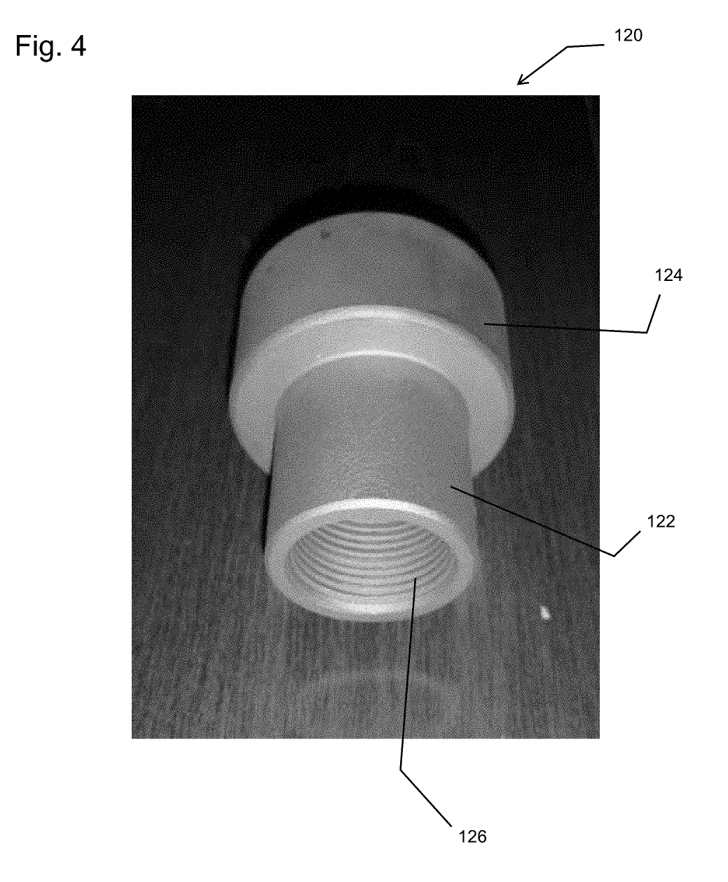

FIG. 5 is a perspective view of a hammering member installed at a read end of a metal tube driven into a soil medium according to an embodiment of the invention; and

FIG. 6 is a perspective view of a boring system installed with a metal tube according to an embodiment of the invention.

### DETAILED DESCRIPTION EMBODIMENTS OF THE INVENTION

Referring to the figures, the embodiments of the invention are described in detail.

An aspect of the invention provides a boring head for steel tubing.

The boring head for metal tubing comprises a cylindrical body, a conic point, and a first engaging female threads.

The cylindrical body has an inner wall portion and an outer wall portion with a predetermined inner diameter and a predetermined outer diameter respectively, and comprises a front opening, a rear opening, and a concentric rear end portion.

The conic point extends from the front opening of the cylindrical body, and is configured to penetrate and bore a hole through an external medium.

The first engaging female threads are provided on a portion of the inner wall portion of the cylindrical body and configured to receive and engage a metal tube put into the cylindrical body, and the metal tube is configured to include first engaging male threads that are corresponding to the first engaging female threads.

The conic point makes a hole through the external medium, being pushed by the metal tube and leading the metal tube through the hole through the external medium.

The conic point may have a predetermined cross-sectional angle, which is determined by the external medium.

The predetermined cross-sectional angle may be from about 15 degrees to about 45 degrees.

The predetermined cross-sectional angle may be from about 20 degrees to about 30 degrees.

The predetermined cross-sectional angle may be about 25 degrees.

The thickness of the cylindrical body may be approximately one fourth to one sixth of the diameter of the inner diameter of the cylindrical body.

The cylindrical body and the conic point may be formed monolithically.

The cylindrical body and the conic point may be made of stainless steel.

Another aspect of the invention provides a boring system for a metal tubing, which comprises a boring head and a hammering member.

The boring head is similar to the one in the previous embodiment.

The hammering member is configured for receiving a rear end of the metal tube and hit by an external force to drive the boring head into the external medium.

The hammering member comprises an engaging portion and and a hammering portion.

The engaging portion includes second engaging female threads and configured to receive the rear end of the metal tube, and the metal tube comprises second engaging male threads corresponding to the second engaging female threads.

The hammering portion is extended from the engaging portion and configured to be hit by an external force.

The engaging portion may have a cylindrical shape and include an inner wall portion and an outer wall portion.

The second engaging female threads are provided on the inner wall portion of the hammering member.

The hammering portion may have a cylindrical shape.

Alternatively, the hammering portion may have a polygon pipe shape.

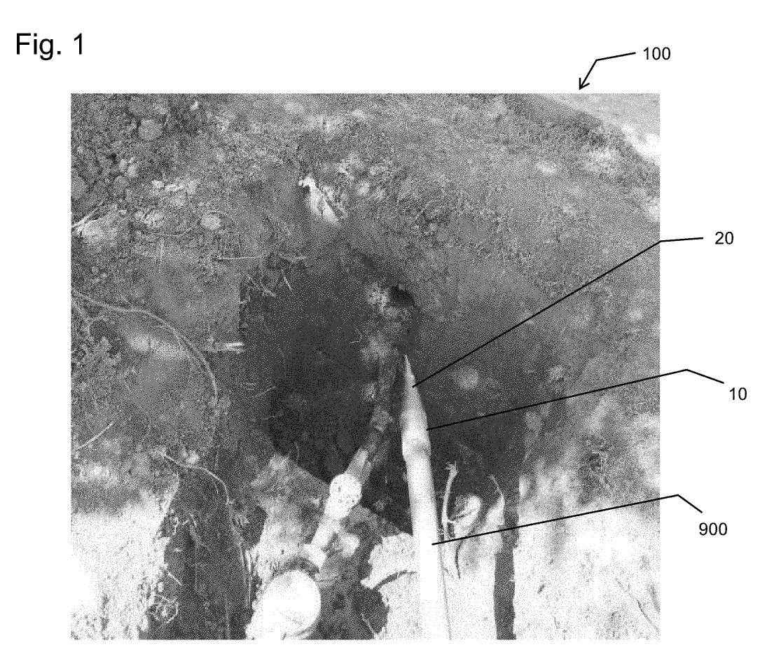

In FIG. 1, the situation in which the boring head according to the invention is about to be inserted into the external medium, the soil. The other external pipe system may be around as illustrated. The metal pipe 900 needs to be installed through the soil, a portion of which may be covered another medium such as concrete pavement. In such an environment, the boring head 100 may be installed at the front end of the metal tube 900 and be pushed through the medium easily without disturbing the surface structure of the soil.

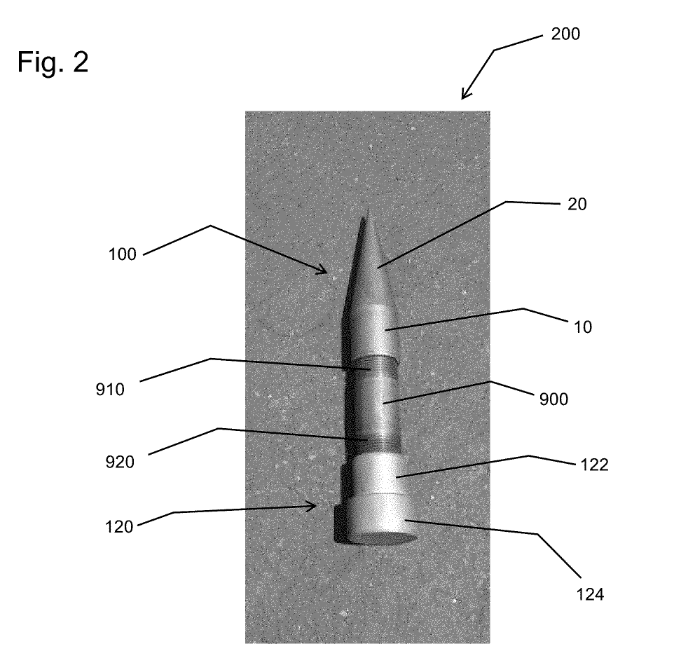

In FIG. 2, of course, a very short metal tube 900 is shown, in order to show how the boring head 100 and the hammering member 120 are installed on the metal tube 900. In a real situation, the metal tube 900 may be very long, so as to penetrate into some external medium.

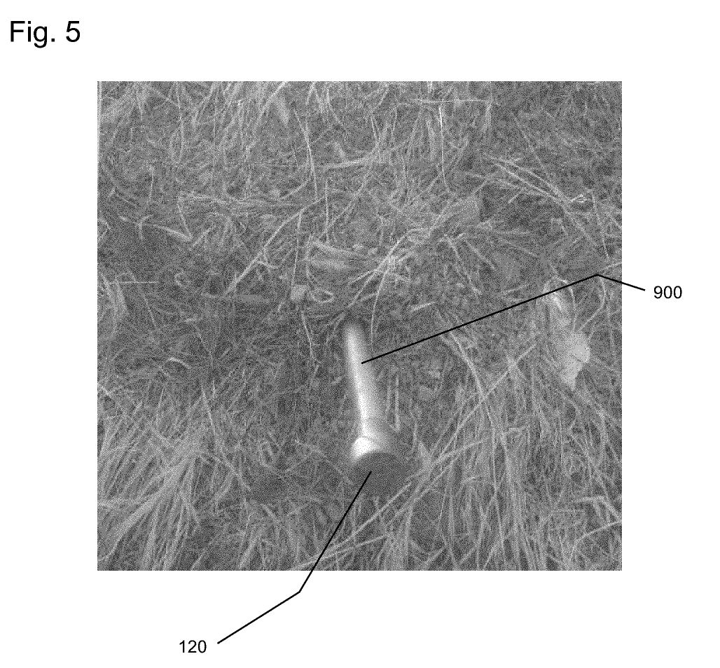

In FIG. 5, the metal tube 900 is already pushed through the external medium, by hammering a metal, rubber, or wooden hammer (not shown) on the rear surface of the hammering member 120.

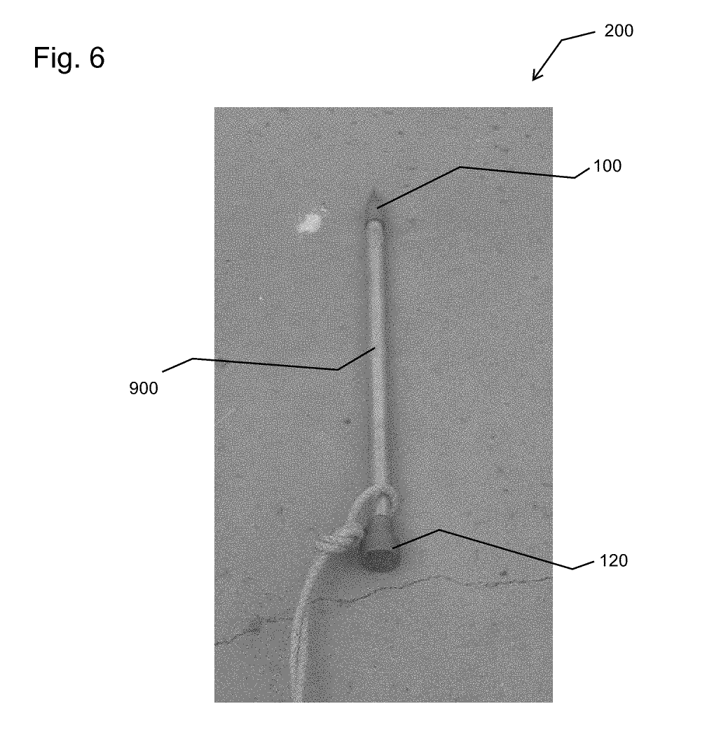

In FIG. 6, the rope is not a part of the invention.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A boring head for metal tubing, the boring head comprising:
a cylindrical body having an inner wall portion and an outer wall portion with a predetermined inner diameter and a predetermined outer diameter respectively, and comprising a front opening, a rear opening, and a concentric rear end portion;
a conic point extending from the front opening of the cylindrical body, and configured to penetrate and bore a hole through an external medium; and
first engaging female threads provided on a portion of the inner wall portion of the cylindrical body and configured to receive and engage a metal tube put into the cylindrical body, wherein the metal tube is configured to include first engaging male threads that are corresponding to the first engaging female threads,
wherein the conic point makes a hole through the external medium, being pushed by the metal tube and leading the metal tube through the hole through the external medium.

2. The boring head of claim 1, wherein the conic point has a predetermined cross-sectional angle, which is determined by the external medium.

3. The boring head of claim 2, wherein the predetermined cross-sectional angle is from about 15 degrees to about 45 degrees.

4. The boring head of claim 3, wherein the predetermined cross-sectional angle is from about 20 degrees to about 30 degrees.

5. The boring head of claim 4, wherein the predetermined cross-sectional angle is about 25 degrees.

6. The boring head of claim 1, wherein the thickness of the cylindrical body is approximately one fourth to one sixth of the diameter of the inner diameter of the cylindrical body.

7. The boring head of claim 1, wherein the cylindrical body and the conic point are formed monolithically.

8. The boring head of claim 7, wherein the cylindrical body and the conic point are made of stainless steel.

9. A boring system for a metal tubing, the boring system comprising:
a boring head according to claim 1; and
a hammering member configured for receiving a rear end of the metal tube and being hit by an external force to drive the boring head into the external medium.

10. The boring system of claim 9, wherein the hammering member comprising:
an engaging portion including second engaging female threads and configured to receive the rear end of the metal tube, wherein the metal tube comprises second engaging male threads corresponding to the second engaging female threads; and
a hammering portion extended from the engaging portion and configured to be hit by an external force.

11. The boring system of claim 10, wherein the engaging portion has a cylindrical shape and includes an inner wall portion and an outer wall portion.

12. The boring system of claim 11, wherein the second engaging female threads are provided on the inner wall portion of the hammering member.

13. The boring system of claim 12, wherein the hammering portion has a cylindrical shape.

14. The boring system of claim 12, wherein the hammering portion has a polygon pipe shape.
